(19) United States
(12) Patent Application Publication
(10) Pub. No.: US 2005/0097238 A1
(43) Pub. Date: May 5, 2005

(54) Peripheral device control program, peripheral device control apparatus and peripheral device control method, and display control program, display control apparatus and display control method

(75) Inventors: Satoshi Oomori, Kanagawa (JP); Kanji Itaki, Kanagawa (JP); Nozomi Noguchi, Kanagawa (JP)

Correspondence Address: OLIFF & BERRIDGE, PLC, P.O. BOX 19928, ALEXANDRIA, VA, 22320, US

(73) Assignee: FUJI XEROX CO., LTD., Tokyo (JP)

(21) Appl. No.: 10/963,726

(22) Filed: Oct. 14, 2004

(30) Foreign Application Priority Data
Oct. 17, 2003 (JP) 2003-358051
Oct. 7, 2004 (JP) 2004-295088

(51) Int. Cl. G06F 3/00

(52) U.S. Cl. 710/15

(57) ABSTRACT

A peripheral device control program which provides a peripheral device with setting information corresponding to setting items set by a user, wherein a computer is caused to implement: processing for display controlling of image data corresponding to the setting information on a displaying unit; and, when a prescribed time period has elapsed since the image data displayed on the displaying unit has been designated with an inputting unit, processing for displaying of text information corresponding to the image data on the displaying unit.

### BACKGROUND OF THE INVENTION

1. Field of the Invention

The present invention relates to a peripheral device control program, a peripheral device control apparatus and a peripheral device control method, and a display control program, a display control apparatus and a display control method, particularly, to a peripheral device control program, a peripheral device control apparatus and a peripheral device control method, and a display control program, a display control apparatus and a display control method which allow the user to easily identify the contents of the setting items for the peripheral device driver.

2. Description of the Related Art

The PC (an acronym of personal computer) and other information processing devices are provided with peripheral devices, and up to now, peripheral devices which can be directly connected to the LAN (an acronym of local area network) have been in wide spread use. To utilize a peripheral device in such a situation, the information required for operating the peripheral device, and the peripheral device driver (or simply the driver) for managing the configuration (functional configuration) of the hardware and software of the peripheral device and the like must be installed in the information processing device.

Here, let's take the printer and the printer peripheral device driver (hereafter abbreviated to the printer driver) as an example for description. The current printer driver is extremely multifunctioned, allowing a variety of settings to be made with the printer driver alone, and thus to identify the contents of the current setting information, it has generally been necessary to examine the indications given on the setting UlI, or to display or print out the list of the contents of the setting information for examination.

For example, as a peripheral device driver providing a variety of pieces of setting information, a printer control apparatus, a printer control method, and a printer control storage medium which allow the contents of the setting information to be identified, displaying the image bit map corresponding to the current setting information on the UI, are available

However, if a plurality of pieces of setting information are provided on a plurality of UIs for setting, being distributed thereto, and all the plurality of pieces of setting information are to be displayed on the UIs for identification, the variety of UIs must be operated so as to display thereon, which is a time consuming work for the user. Further, when a list of the contents of the setting information is to be displayed or printed out for identification, interventional control to provide a tree indication for listing must be performed, which is bothersome for the user, and because of the listing, all the pieces of unnecessary setting information are also displayed, being mixed, thus it has been difficult to find out the pertinent pieces of setting information.

### SUMMARY OF THE INVENTION

The present invention has been made in view of the above circumstances and provides a peripheral device control program, a peripheral device control apparatus and a peripheral device control method, and a display control program, a display control apparatus and a display control method which, by utilizing the tool tip (the function which displays a text window when the cursor is placed on the control for a prescribed time period or longer), allows the user to easily identify the contents of the setting information.

An aspect of the present invention provides a peripheral device control program which provides a peripheral device with setting information corresponding to setting items set by a user, wherein a computer is caused to implement:

processing for display controlling of image data corresponding to the setting information on a display; and,

processing for displaying of text information corresponding to the image data on the display, when a prescribed time period has elapsed since the image data displayed on the display has been designated with an inputting unit.

Another aspect of the present invention provides a display control program which carries out display controlling of a display, wherein a computer is caused to implement:

processing for display controlling image data corresponding to a peripheral device on the display;

processing for identifying the peripheral device corresponding to the image data, when a prescribed time period has elapsed since the image data displayed on the display has been designated with an inputting unit;

processing for reading out the setting information set in the peripheral device control program corresponding to the specified peripheral device; and

processing for displaying the text information indicating the read out setting information on the display.

### BRIEF DESCRIPTION OF THE DRAWINGS

Embodiments of the present invention will be described in detail based on the following figures, wherein:

FIG. 1 is a block diagram illustrating an example of functional configuration of the peripheral device control program, the peripheral device control apparatus, and the peripheral device control method according to the present invention;

FIG. 2 is a flow chart illustrating the procedure for processing that is to be taken by the printer driver 4 when the tool tip indicating the setting information is displayed;

FIG. 3 is a drawing illustrating an example of property window 16 for the printer driver 4 that is displayed on the displaying apparatus 8;

FIG. 4 is a block diagram illustrating a part of the functional configuration of the printer driver 4 that carries out the framing;

FIG. 5 is a flow chart illustrating the procedure for processing that is to be taken by the printer driver 4 when the framing is performed;

FIG. 6A and FIG. 6B are drawings illustrating an example of property window 16 for the printer driver 4 that is displayed on the displaying apparatus 8;

FIG. 7 is a drawing illustrating an example of property window 16 for the printer driver 4 that is displayed on the displaying apparatus 8;

FIG. 8 is a block diagram illustrating a part of the functional configuration of the printer driver 4 that carries out the tool tip display control;

FIG. 9 is a flow chart illustrating the procedure for processing that is to be taken by the printer driver 4 when the tool tip display control is performed;

FIG. 10A and FIG. 10B are drawings illustrating an example of property window 16 for the printer driver 4 that is displayed on the displaying apparatus 8;

FIG. 11A and FIG. 11B are drawings illustrating an example of property window 16 for the printer driver 4 that is displayed on the displaying apparatus 8;

FIG. 12 is a block diagram illustrating an example of functional configuration of an OS 36 which carries out tool tip display control;

FIG. 13 is a flow chart illustrating the procedure for processing that is to be taken by the OS 36 when the tool tip indicating the setting information is displayed;

FIG. 14 is a drawing illustrating an example of printer screen 37 which is displayed on the displaying apparatus; and

FIG. 15 is a drawing illustrating an example of property window 16 for the printer driver 4 that is displayed on the displaying apparatus 8.

### DESCRIPTION OF THE EMBODIMENTS

Hereinbelow, embodiments of the peripheral device control program, the peripheral device control apparatus and the peripheral device control method, and a display control program, a display control apparatus and a display control method according to the present invention will be specifically described with reference to the accompanying drawings.

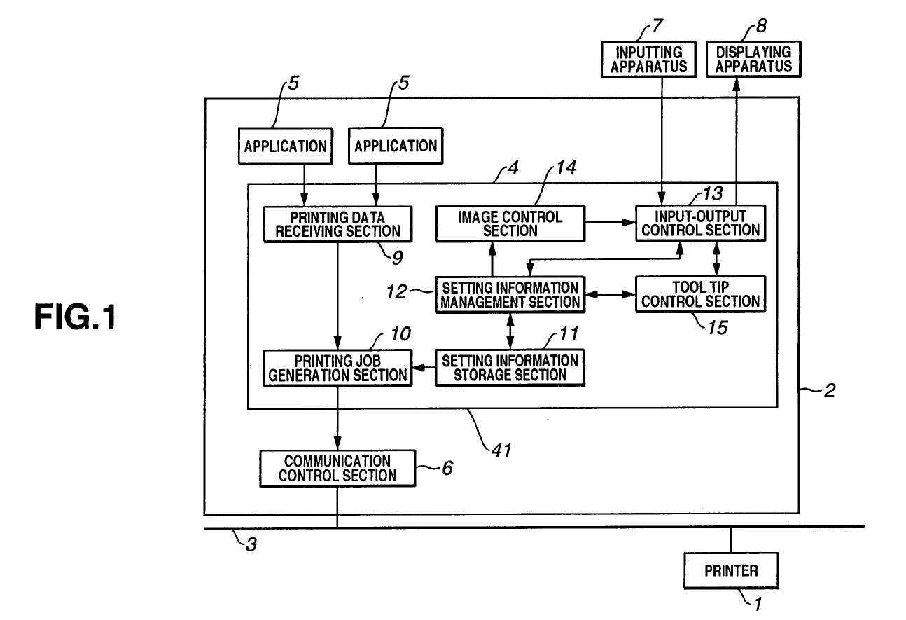

FIG. 1 is a block diagram illustrating an example of functional configuration of the peripheral device control program, the peripheral device control apparatus, and the peripheral device control method according to the present invention. In FIG. 1, a printer 1, which is a peripheral device, and a client 2 are connected to a network 3, and in the client 2, a printer driver 4, which is a peripheral device control program for the printer 1, is installed.

As shown in FIG. 1, the client 2 comprises the printer driver 4 having a program and data for generating a printing job or the like, a variety of applications 5 which are realized by application programs, and a communication control section 6 for carrying out the communication control to communicate through the network 3. These implement a variety of processings using the functions of the OS (an acronym of operating system) under the control by the OS (not shown). To the client 2, an inputting apparatus 7, such as a keyboard or a mouse, and a displaying apparatus 8, such as a display, are connected.

Here, the functional configuration of the printer driver 4 will be described in detail.

As shown in FIG. 1, the printer driver 4 comprises, as its features, a printing data receiving section 9 which receives printing data from the application 5; a printing job generating section 10 which generates a printing job on the basis of the printing data and the setting information for the printer 1; a setting information storage section 11; a setting information management section 12; an input-output control section 13; an image control section 14; and a tool tip control section 15.

The setting information storage section 11 stores and holds the functional configuration of the hardware and software for the printer 1, and the setting information which indicates the settings and the like to be used in printer outputting.

The setting information management section 12 carries out management and updating of the setting information which is stored and held in the setting information storage section 11.

The input-output control section 13 carries out input processing for receiving an instruction from the inputting apparatus 7, and output processing for causing the displaying apparatus 8 to display a guide screen (hereafter to be called a property window) and the like for the printer driver 4.

The image control section 14 selects the image corresponding to the setting information stored and held in the setting information storage section 11 from the previously generated images indicating the setting information in displaying the property window for the printer driver 4 on the displaying apparatus 8, and causes the input-output control section 13 to display the selected image on the property window.

The tool tip control section 15 causes the input-output control section 13 to display the text information (hereafter to be called the tool tip) indicating the setting information stored and held in the setting information storage section 11 on the property window when the cursor or the like is placed, for a certain period of time or longer, on the image indicating the setting information that is displayed on the property window.

Next, the functional operations which are carried out by the printer driver 4 when the tool tip indicating the setting information is displayed will be described.

When the input-output control section 13 receives an instruction for displaying the property window from the inputting apparatus 7, the input-output control section 13 notifies the setting information management section 12 of the instruction for displaying the property window having been received, and when the setting information management section 12 is notified of the instruction for displaying the property window having been received, the setting information management section 12 reads out the setting information stored and held in the setting information storage section 11, and outputs the read out setting information to the input-output control section 13, while outputting the setting information to be displayed as an image on the property window to the image control section 14.

When the image control section 14 receives the setting information, the image control section 14 selects the image corresponding to the received setting information from the previously generated images indicating the setting information, and outputs the selected image to the input-output control section 13; when the input-output control section 13 receives the setting information from the setting information management section 12 and the image from the image control section 14, the input-output control section 13 generates a property window on the basis of the received setting information and image, and transmits the generated property window to the displaying apparatus 8; and when the displaying apparatus 8 receives the property window, the displaying apparatus 8 displays the received property window on the display or the like.

Then, the cursor operated by using the inputting apparatus 7 is placed on the image on the property window displayed on the displaying apparatus 8, the input-output control section 13 notifies the tool tip control section 15 of the cursor being placed on the image, and when the tool tip control section 15 is notified of the cursor being placed on the image, the tool tip control section 15 starts measuring the elapsed time for displaying the tool tip.

When the prescribed time period has elapsed with the cursor being placed on the image, the tool tip control section 15 notifies the setting information management section 12 of the tool tip being to be displayed; when the setting information management section 12 is notified of the tool tip being to be displayed, the setting information management section 12 reads out the setting information stored and held in the setting information storage section 11, and outputs the read out setting information to the tool tip control section 15; when the tool tip control section 15 receives the setting information, the tool tip control section 15 converts the received setting information into the text information for generating a tool tip, and outputs the generated tool tip to the input-output control section 13; when the input-output control section 13 receives the tool tip, the input-output control section 13 transmits the received tool tip to the displaying apparatus 8; and when the displaying apparatus 8 receives the tool tip, the displaying apparatus 8 displays the received tool tip on the display or the like.

Then, when the cursor is moved to leave the image, the input-output control section 13 notifies the displaying apparatus 8 of the tool tip display being to be closed, and when the displaying apparatus 8 is notified of the tool tip display being to be closed, the displaying apparatus 8 closes the tool tip displayed on the display or the like.

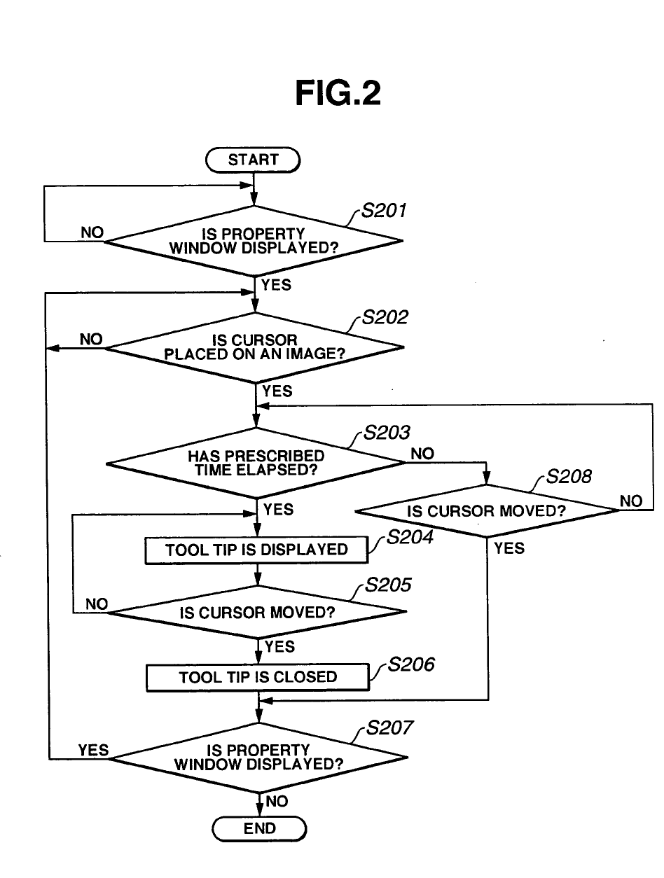

Next, the procedure for processing that is to be taken by the printer driver 4 when the tool tip indicating the setting information is displayed will be described with reference to the flow chart as shown in FIG. 2.

The property window is displayed (YES at step S201), and when the cursor is placed on the image (YES at step S202), and the prescribed time period has elapsed (YES at step S203), the tool tip is displayed (step S204).

When the cursor is moved (YES at step S205), the tool tip window is closed (at step S206), and the property window is closed (NO at step S207), the procedure for processing is ended.

At the step S203, when the cursor is moved (YES at step S208) before the prescribed time period has elapsed (NO at step S203), the tool tip will not be displayed.

Next, the processing for displaying the tool tip indicating the setting information will be described in detail with reference to a specific embodiment.

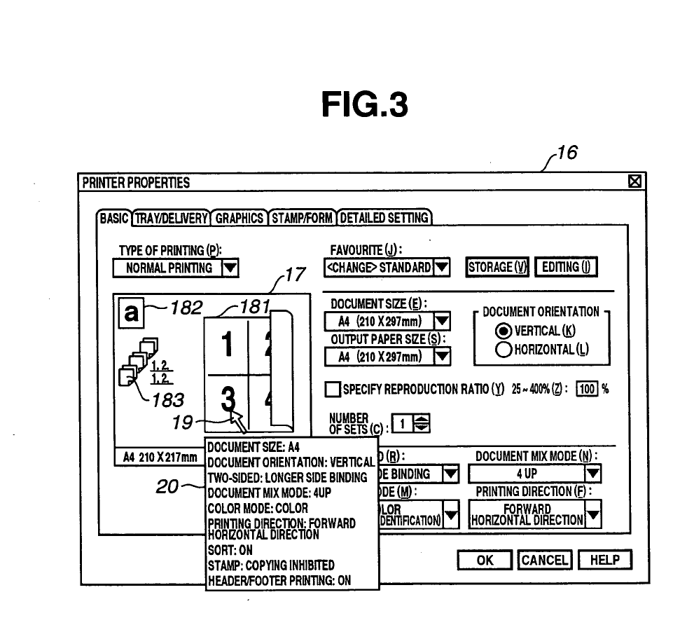

FIG. 3 is a drawing illustrating an example of property window 16 for the printer driver 4 that is displayed on the displaying apparatus 8.

As shown in FIG. 3, in the property window 16 for the printer driver 4, combo boxes, check boxes, and the like for providing a variety of pieces of setting information are displayed; for example, “A4” is provided as setting information for “document size”, and “vertical” is provided as setting information for “orientation of document”.

The images indicating these pieces of setting information are displayed in an image region 17 on the property window. For example, as shown in FIG. 3, an image A181 indicates that “longer side binding” is provided as setting information for “two-sided”; “4 up” is provided as setting information for “document mix mode”; “color” is provided as setting information for “color mode”; and “forward horizontal direction” is provided as setting information for “printing direction”; an image B 182 indicates that “vertical” is provided as setting information for “document orientation”; and an image C183 indicates that “sort ON” is provided as setting information for “sort”.

By placing a cursor 19 on the image Al 81, the image B182, and the image C183 for a prescribed period of time, a tool tip 20 indicating the setting information is displayed. For example, as shown in FIG. 3, when the cursor 19 is placed on the image Al81, the setting information to be indicated by the image A181 (“longer side binding” for “two-sided”; “4 up” for “document mix mode”; “color” for “color mode”; and “forward horizontal direction” for “printing direction”), the setting information to be indicated by the image B 182 (“vertical” for “document orientation”), the setting information to be indicated by the image C183 (“sort ON” for “sort”), and the setting information that is not indicated by the image (“A4” provided as setting information for “document size”; “copying inhibited provided as setting information for “stamp”; and “ON” provided as setting information for “header/footer printing”) are displayed as a tool tip 20.

Thus, by using the tool tip for expressing the setting information corresponding to the image as text information, the relationship between the image and the setting information can be expressed more comprehensively, and also the setting information that is difficult to be expressed only by the image (such as an entry with a numerical value and that of an arbitrary character string) can be expressed accurately and comprehensively as text information.

Next, the framing wherein the setting information is divided into groups, and for each particular group, whether the display is to be carried out with the image or the tool tip is set will be described.

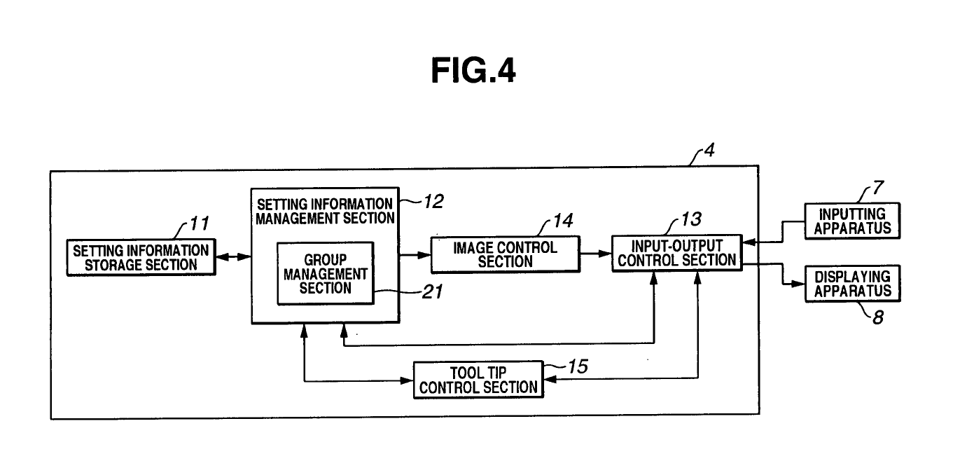

FIG. 4 is a block diagram illustrating a part of the functional configuration of the printer driver 4 that carries out the framing.

As shown in FIG. 4, the printer driver 4 comprises, as its features, the setting information storage section 11, the setting information management section 12, the input-output control section 13, the image control section 14, and the tool tip control section 15. Since the other features are the same as those as given in FIG. 1, the description is omitted. Also, since the setting information storage section 11, the input-output control section 13, the image control section 14, and the tool tip control section 15 are the same as those in FIG. 1, detailed description of them is omitted.

The setting information management section 12 comprises a group management section 21 which manages the groups created by dividing the setting information, and manages and updates the setting information which is stored and held in the setting information storage section 11.

Next, the functional operations to be made when the printer driver 4 performs framing will be described.

When the input-output control section 13 receives, from the inputting apparatus 7, an instruction for dividing the setting information into groups and the setting for framing for each particular group, the input-output control section 13 outputs the instruction for dividing the information into groups and the setting for framing for each particular group to the setting information management section 12; when the setting information management section 12 receives the instruction for dividing the setting information into groups and the setting for framing for each particular group, the group management section 21 divides the setting information stored and held in the setting information storage section 11 into groups, and on the basis of the setting for framing for each particular group, implements the setting for framing for the respective divided groups.

Then, when the property window is displayed on the displaying apparatus 8, and the cursor operated by using the inputting apparatus 7 is placed on the image on the property window displayed on the displaying apparatus 8, the input-output control section 13 notifies the tool tip control section 15 of the cursor being placed on the image; when the tool tip control section 15 is notified of the cursor being placed on the image, the tool tip control section 15 notifies the setting information management section 12 of the cursor being placed on the image; and when the setting information management section 12 is notified of the cursor being placed on the image, the setting information management section 12 inquires of the group management section 21 about the setting for framing for each particular group.

Here, when there is a group set for tool tip display, the setting information management section 12 notifies the tool tip control section 15 of there being a group set for tool tip display, and when the tool tip control section 15 is notified of there being a group set for tool tip display, the tool tip control section 15 starts measuring the elapsed time for displaying the tool tip. Contrarily, when there is no group set for tool tip display, the setting information management section 12 notifies the tool tip control section 15 of there being no group set for tool tip display, and when the tool tip control section 15 is notified of there being no group set for tool tip display, the tool tip control section 15 will not display the tool tip.

When there is a group set for tool tip display, and the prescribed time period has elapsed with the cursor being placed on the image, the tool tip control section 15 notifies the setting information management section 12 of the tool tip being to be displayed; when the setting information management section 12 is notified of the tool tip being to be displayed, the setting information management section 12 reads out the setting information belonging to the group set for tool tip display from the setting information stored and held in the setting information storage section 11, and outputs the read out setting information to the tool tip control section 1.5; when the tool tip control section 15 receives the setting information, the tool tip control section 15 converts the received setting information into the text information for generating a tool tip, and outputs the generated tool tip to the input-output control section 13; when the input-output control section 13 receives the tool tip, the input-output control section 13 transmits the received tool tip to the displaying apparatus 8; and when the displaying apparatus 8 receives the tool tip, the displaying apparatus 8 displays the received tool tip on the display or the like.

Then, when the cursor is moved to leave the image, the input-output control section 13 notifies the displaying apparatus 8 of the tool tip display being to be closed, and when the displaying apparatus 8 is notified of the tool tip display being to be closed, the displaying apparatus 8 closes the tool tip window displayed on the display or the like.

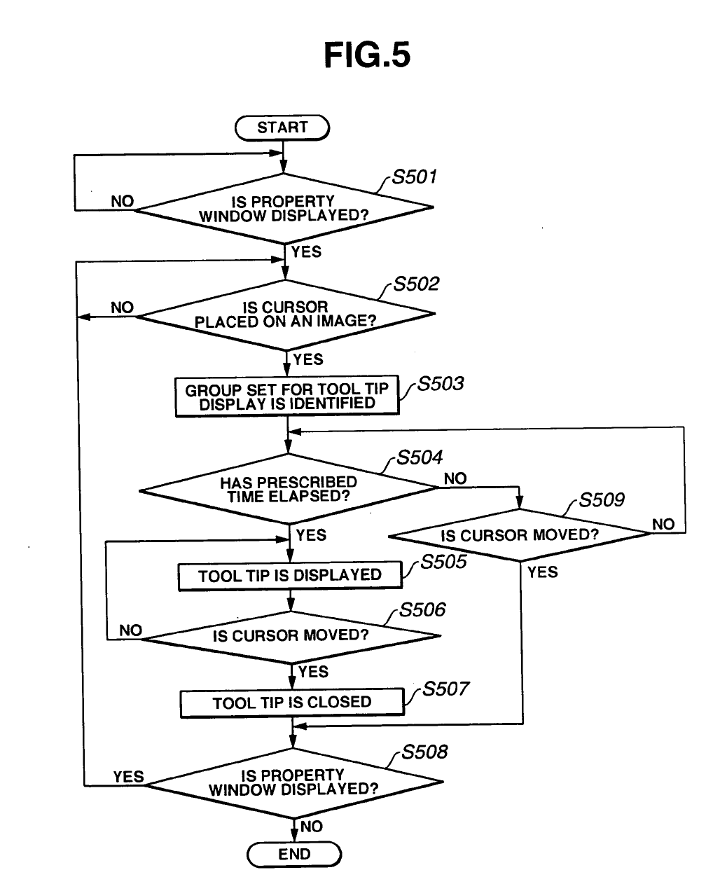

Next, the procedure for processing that is to be taken by the printer driver 4 when the framing is performed will be described with reference to the flow chart as shown in FIG. 5.

The property window is displayed (YES at step S501), and when the cursor is placed on the image (YES at step S502), a group set for tool tip display is identified (at step S503); when the prescribed time period has elapsed (YES at step S504), the setting information for the group set for tool tip display is displayed as a tool tip (at step S505); when the cursor is moved (YES at step S506), the tool tip window is closed (at step S507); and when the property window is closed (NO at step S508), the procedure for processing is ended.

At the step S504, when the cursor is moved (YES at step S509) before the prescribed time period has elapsed (NO at step S504), the tool tip will not be displayed.

Next, the processing for performing the framing will be described in detail with reference to a specific embodiment.

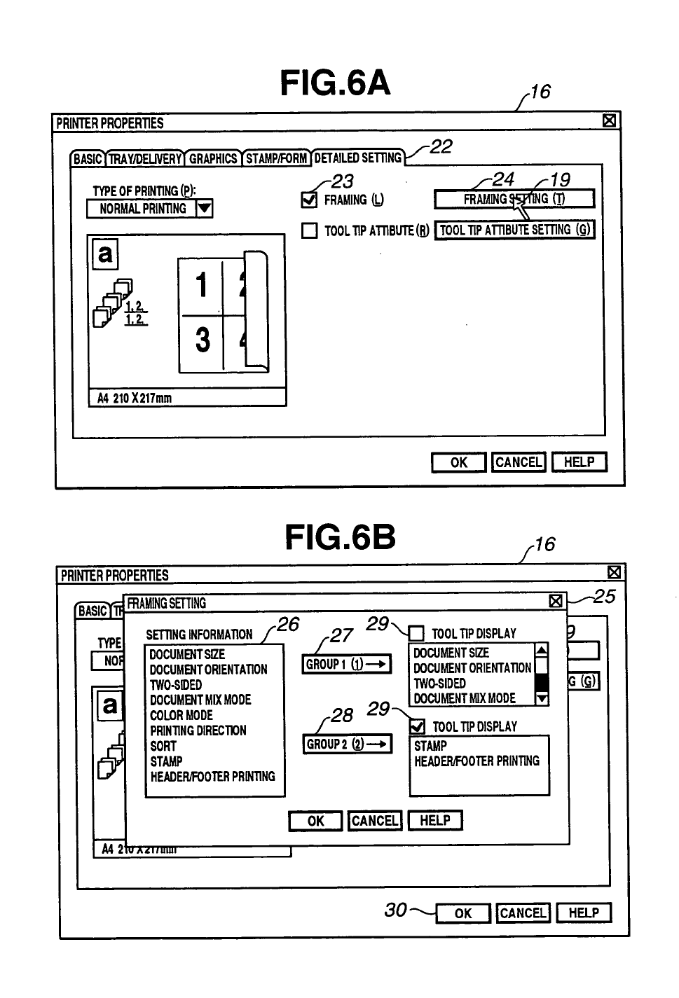

FIG. 6A and FIG. 6B are drawings illustrating an example of property window 16 for the printer driver 4 that is displayed on the displaying apparatus 8. As shown in FIG. 6A, in the property window 16 for the printer driver 4, a card for “basic”, a card for “tray/delivery”, a card for “graphics”, a card for “stamp/form”, and a card for “detailed setting”, 22, are provided, and for performing the setting for dividing the setting information into groups, it is necessary to open the card for “detailed setting”, 22.

In the card for “detailed setting”, 22, a check box for setting the framing, 23, is displayed. Here, a check mark is entered in the check box for setting the framing, 23, and operating a button for “framing setting”, 24, will display a framing setting window as shown in FIG. 6B.

As shown in FIG. 6B, the framing setting window 25 allows the setting information to be divided into groups, and setting the framing for each particular group to be carried out. For example, when a plurality of pieces of setting information as shown in FIG. 6B is to be divided into a group which is to be displayed with the image (hereafter to be called the group 1) and that which is to be displayed with the tool tip (hereafter to be called the group 2), selecting the “document size” from a list of pieces of setting information, 26, and operating a button for the “group 1 ”, 27, will set the setting information of “document size” at the “group 1”, and selecting the “stamp” from the list of pieces of setting information, and operating a button for the “group 2”, 28, will set the setting information of “stamp” at the “group 2”. By entering a check mark in a check box for tool tip display, 29, the setting information for that group can be set for tool tip display, and by entering no check mark in a check box for tool tip display, 29, the setting information for that group can be set for image display.

Then, by operating a button for “OK”, 30, the division into groups and the setting for framing for each particular group can be established, and with such establishment, the framing setting window 25 will be closed.

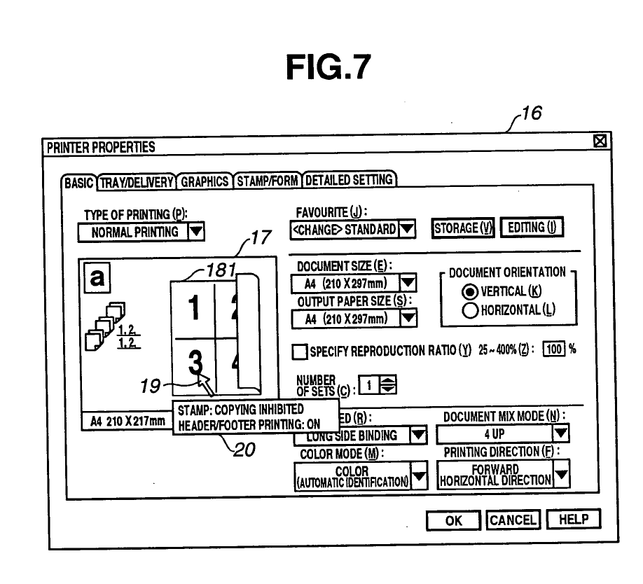

As shown in FIG. 7, when a cursor 19 is placed on an image A181, displayed in an image region 17, the setting information for the “group 2” set for tool tip display (“copying inhibited” for “stamp”, and “ON” for “header/footer printing”) is displayed as a tool tip 20.

Thus, by narrowing down the setting information which can be expressed with the tool tip, the recognizability of the setting information can be bettered.

Next, the tool tip display control wherein, for each particular piece of setting information, the display/non-display of the tool tip is set will be described.

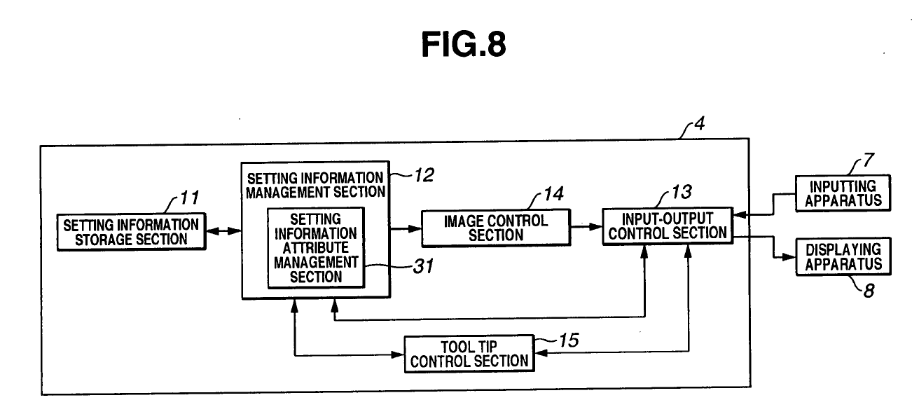

FIG. 8 is a block diagram illustrating a part of the functional configuration of the printer driver 4 that carries out the tool tip display control.

As shown in FIG. 8, the printer driver 4 comprises, as its features, the setting information storage section 11, the setting information management section 12, the input-output control section 13, the image control section 14, and the tool tip control section 15. Since the other features are the same as those as given in FIG. 1, the description is omitted. Also, since the setting information storage section 11, the input-output control section 13, the image control section 14, and the tool tip control section 15 are the same as those in FIG. 1, detailed description of them is omitted.

The setting information management section 12 comprises a setting information attribute management section 31 which manages the setting information attributes for setting the display/non-display of the tool tip for each particular piece of setting information, and manages and updates the setting information which is stored and held in the setting information storage section 11.

Next, the functional operations to be made when the printer driver 4 performs the tool tip display control will be described.

When the input-output control section 13 receives, from the inputting apparatus 7, the setting information attributes for setting the display/non-display of the tool tip for each particular piece of setting information, the input-output control section 13 outputs the setting information attributes to the setting information management section 12; when the setting information management section 12 receives the setting information attributes, the setting information attribute management section 31 sets the setting information attribute for each particular piece of setting information which is stored and held in the setting information storage section 11, on the basis of the setting information attributes.

Then, when the property window is displayed on the displaying apparatus 8, and the cursor operated by using the inputting apparatus 7 is placed on the image on the property window displayed on the displaying apparatus 8, the input-output control section 13 outputs the information for the image on which the cursor is placed, to the tool tip control section 15; when the tool tip control section 15 receives the information for the image, the tool tip control section 15 outputs the received information for the image to the setting information management section 12; and when the setting information management section 12 receives the information for the image, the setting information management section 12 inquires of the setting information attribute management section 31 about the setting information attributes which are set for the setting information indicated by the image.

Here, when any of the setting information attributes of the setting information which have been inquired is set for tool tip display, the tool tip control section 15 is notified of any of the setting information attributes being set for tool tip display; and when the tool tip control section 15 is notified of any of the setting information attributes being set for tool tip display, the tool tip control section 15 starts measuring the time for displaying the tool tip. Contrarily, when none of the setting information attributes of the setting information which have been inquired is set for tool tip display, the tool tip control section 15 is notified of none of the setting information attributes being set for tool tip display; and when the tool tip control section 15 is notified of none of the setting information attributes being set for tool tip display, the tool tip control section 15 will not display the tool tip.

When any of the setting information attributes of the setting information indicated by the image on which the cursor is placed is set for tool tip display, and the prescribed time period has elapsed with the cursor being placed on the image, the tool tip control section 15 notifies the setting information management section 12 of the tool tip being to be displayed; when the setting information management section 12 is notified of the tool tip being to be displayed, the setting information management section 12 reads out the setting information indicated by the image on which the cursor is placed, and any of which setting information attributes is set for tool tip display, from the setting information stored and held in the setting information storage section 11, and outputs the read out setting information to the tool tip control section 15; when the tool tip control section 15 receives the setting information, the tool tip control section 15 converts the received setting information into the text information for generating a tool tip, and outputs the generated tool tip to the input-output control section 13; when the input-output control section 13 receives the tool tip, the input-output control section 13 transmits the received tool tip to the displaying apparatus 8; and when the displaying apparatus 8 receives the tool tip, the displaying apparatus 8 displays the received tool tip on the display or the like.

Then, when the cursor is moved to leave the image, the input-output control section 13 notifies the displaying apparatus 8 of the tool tip display being to be closed, and when the displaying apparatus 8 is notified of the tool tip display being to be closed, the displaying apparatus 8 closes the tool tip window displayed on the display or the like.

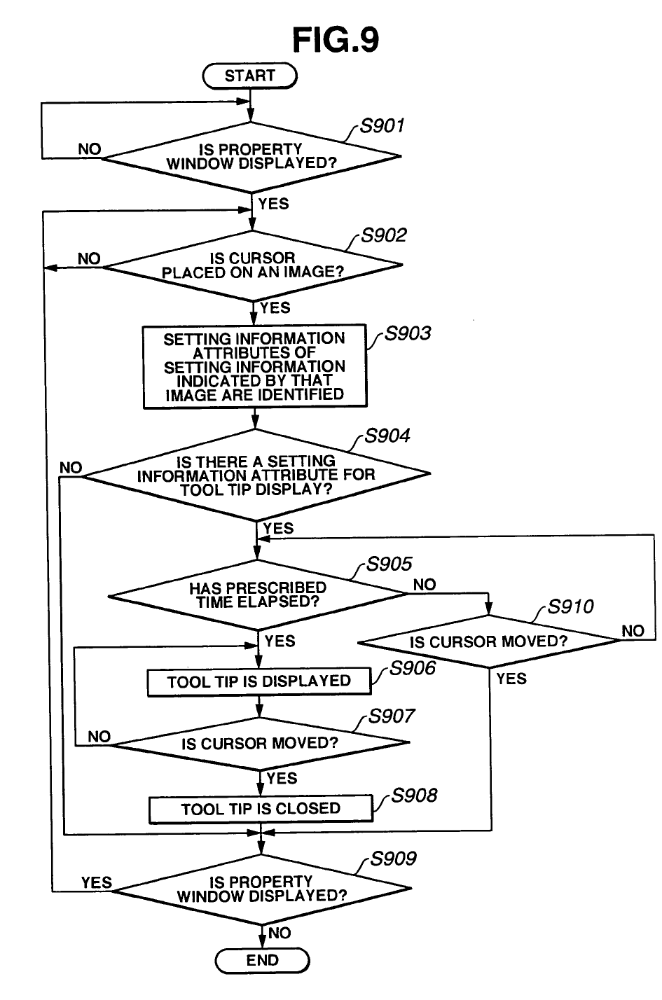

Next, the procedure for processing that is to be taken by the printer driver 4 when the tool tip display control is performed will be described with reference to the flow chart as shown in FIG. 9.

The property window is displayed (YES at step S901), and when the cursor is placed on the image (YES at step S902), the setting information attributes of the setting information indicated by that image are identified (at step S903).

When, among the setting information attributes, there is a setting information attribute set for tool tip display (YES at step S904), and the prescribed time period has elapsed (YES at step S905), the setting information which setting information attribute is set for tool tip display is displayed as a tool tip (at step S906); when the cursor is moved (YES at step S907), the tool tip window is closed (at step S908); and when the property window is closed (NO at step S909), the procedure for processing is ended.

At the step S904, when, among the setting information attributes, there is no setting information attribute set for tool tip display (NO at step S904), no tool tip will be displayed.

Further, at the step S905, when the cursor is moved (YES at step S910) before the prescribed time period has elapsed (NO at step S905), the tool tip will not be displayed.

Next, the processing for performing the tool tip display control will be described in detail with reference to a specific embodiment.

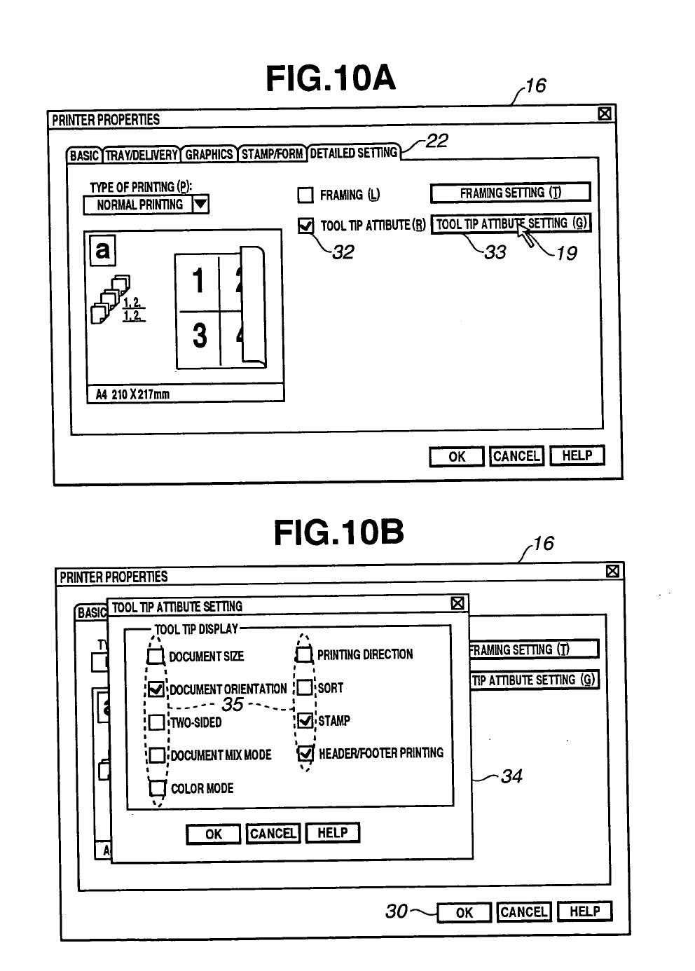

FIG. 10A and FIG. 10B are drawings illustrating an example of property window 16 for the printer driver 4 that is displayed on the displaying apparatus 8.

As shown in FIG. 10A, in the property window 16 for the printer driver 4, a card for “basic”, a card for “tray/delivery”, a card for “graphics”, a card for “stamp/form”, and a card for “detailed setting”, 22, are provided, and for performing the setting for the tool tip display control, it is necessary to open the card for “detailed setting”, 22.

In the card 22 for “detailed setting”, a check box 32 for setting for tool tip display control, is displayed. Here, a check mark is entered in the check box 32 for setting for tool tip display control, and operating a button 33for “tool tip attribute setting” will display a tool tip attribute setting window 34 as shown in FIG. 10B.

As shown in FIG. 10B, the tool tip attribute setting window 34 allows setting the display/non-display of the tool tip for each particular group to be carried out, and by entering a check mark in a check box 35 for setting for tool tip display, the setting information can be set for tool tip display. For example, as shown in FIG. 10B, a check mark is entered in the respective check boxes 35 for the pieces of setting information of “document orientation”, “stamp”, and “header/footer printing”, thus, the pieces of setting information of “document orientation”, “stamp”, and “header/footer printing” are displayed with the tool tip.

Then, by operating a button for “OK”, 30, the setting of the display/non-display of the tool tip can be established, and with such establishment, the tool tip attribute setting window 34 will be closed.

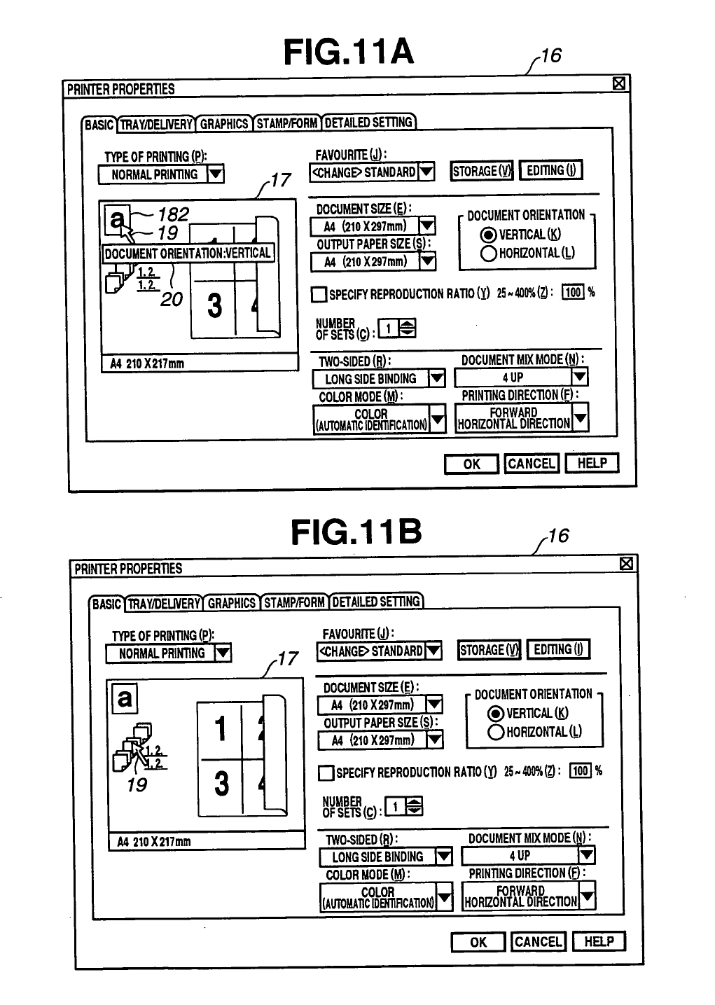

FIG. 11A and FIG. 11B are drawings illustrating an example of property window 16 for the printer driver 4 that is displayed on the displaying apparatus 8.

As shown in FIG. 11 A, the setting information indicated by an image B182 displayed in an image region 17 is set for tool tip display, thus, when the cursor 19 is placed on the image B182, the setting information indicated by the image B182 (“vertical” for “orientation of document”) is displayed as a tool tip 20.

Further, as shown in FIG. 11B, the setting information indicated by an image C183 displayed in an image region 17 is set for tool tip display, thus, even when the cursor 19 is placed on the image C183, the setting information indicated by the image C183 (“ON” for “sort”) is not displayed as a tool tip 20.

Thus, by adding the setting information attributes, not only narrowing down the quantity of text but also controlling the display of the text for each particular piece of setting information by holding the setting information attribute of the respective pieces of setting information are made possible, whereby the need for displaying the unnecessary text, such as the choice (a piece of setting information) meaning “function OFF”, can be eliminated.

Next, the displaying method which displays the tool tip indicating the setting information without the need for displaying the property window for the printer driver will be described.

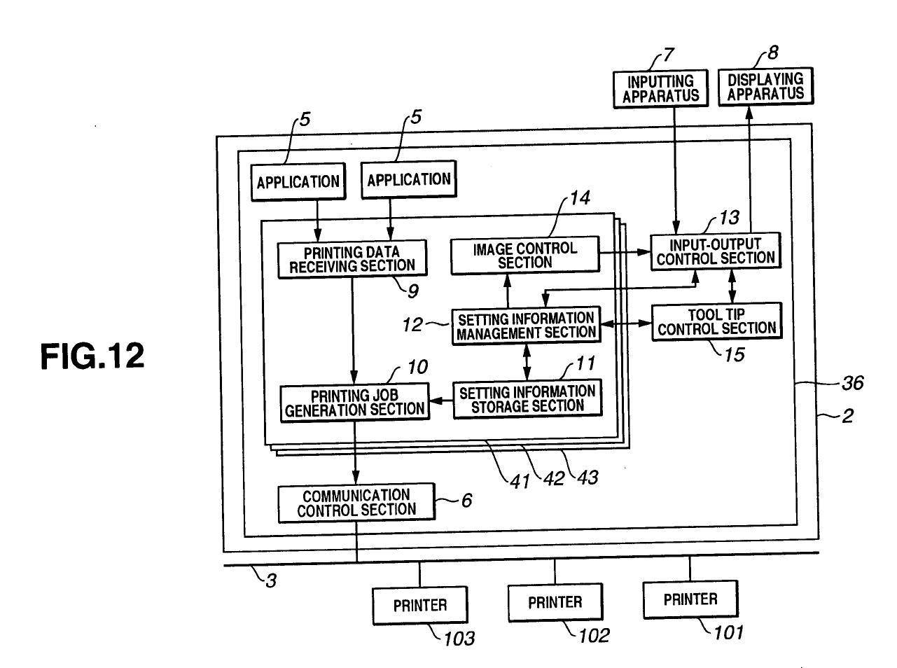

FIG. 12 is a block diagram illustrating an example of functional configuration of an OS 36 which carries out tool tip display control.

As shown in FIG. 12, the OS 36 comprises, as its features, an input-output control section 13, and a tool tip control section 15, and further comprises a printer driver 41, 42, 43 for each destination (i.e., a printer 101, 102, 103) that has a setting information storage section 11, a setting information management section 12, and an image control section 14. Since the other features are the same as those as given in FIG. 1, the description is omitted.

The input-output control section 13, which is provided in the OS 36, carries out input processing for receiving an instruction from an inputting apparatus 7, and output processing for causing a displaying apparatus 8 to display a screen for specifying the printer and setting the initial values for the printer (hereafter to be called a printer screen). The input-output control section 13 also carries out processings for reading out the setting information stored and held in the setting information storage section 11 and writing in through the setting information management section 12 of the printer driver.

The tool tip control section 15 provided in the OS 36 previously stores and holds the printer corresponding to a particular printer image displayed on the printer screen, and when the cursor or the like has been placed on a particular printer image displayed on the printer screen, the tool tip control section 15 identifies the printer corresponding to that printer image, and causes the input-output control section 13 to display the text information indicating the setting information stored and held in the setting information storage section 11 of the printer driver for the identified printer on the printer screen.

Next, the functional operations which are carried out by the OS 36 when the tool tip indicating the setting information is displayed will be described.

When the input-output control section 13 receives an instruction for displaying the printer screen from the inputting apparatus 7, the input-output control section 13 controls the displaying apparatus 8 so as to display the printer screen.

When the cursor operated with the inputting apparatus 7 is placed on any of the destination printer images on the printer screen displayed on the displaying apparatus 8, the input-output control section 13 notifies the tool tip control section 15 of the cursor being placed on a destination printer image, and when the tool tip control section 15 is notified of the cursor being placed on a destination printer image, the tool tip control section 15 starts measuring the elapsed time for displaying the tool tip.

When the prescribed time period has elapsed with the cursor being placed on the image, the tool tip control section 15 identifies the printer corresponding to the printer image on which the cursor is placed, and notifies the setting information management section 12 of the printer driver corresponding to that printer of the tool tip being to be displayed; when the setting information management section 12 of the printer driver corresponding to that printer is notified of the tool tip being to be displayed, the setting information management section 12 of the printer driver corresponding to that printer reads out the setting information stored and held in the setting information storage section 11, and outputs the read out setting information to the image control section 14; when the image control section 14 receives the setting information, the image control section 14 converts the received information into the text information for generating a tool tip, and outputs the generated tool tip to the input-output control section 13; when the input-output control section 13 receives the tool tip, the input-output control section 13 transmits the received tool tip to the displaying apparatus 8; and when the displaying apparatus 8 receives the tool tip, the displaying apparatus 8 displays the received tool tip on the display or the like.

Then, when the cursor is moved to leave the image, the input-output control section 13 notifies the displaying apparatus 8 of the tool tip display being to be closed, and when the displaying apparatus 8 is notified of the tool tip display being to be closed, the displaying apparatus 8 closes the tool tip window displayed on the display or the like.

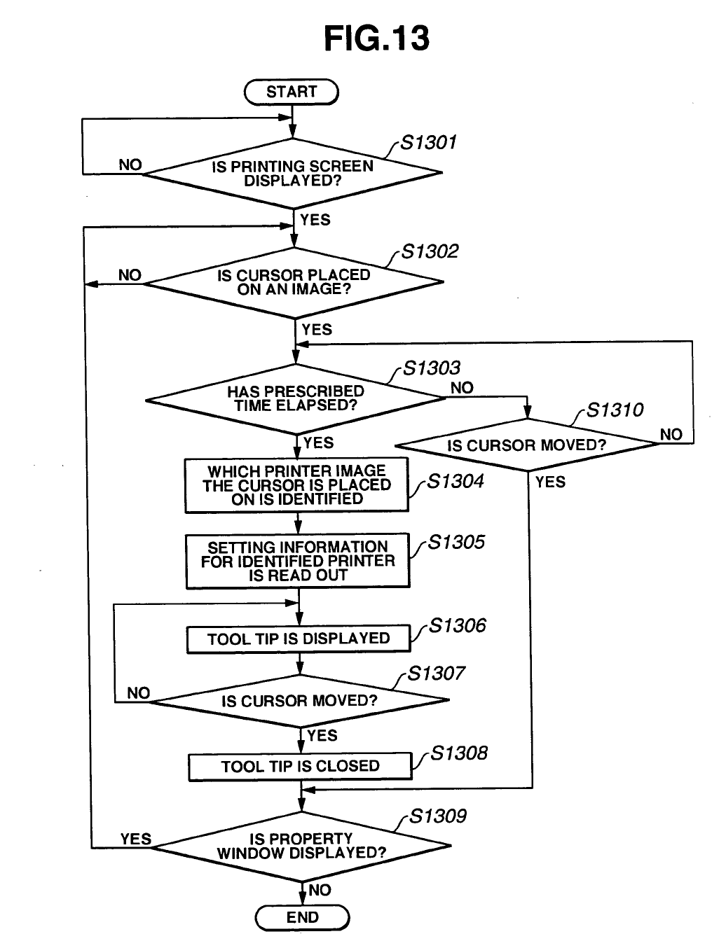

Next, the procedure for processing that is to be taken by the OS 36 when the tool tip indicating the setting information is displayed will be described with reference to the flow chart as shown in FIG. 13.

The printer screen is displayed (YES at step S1301), and when the cursor is placed on an image (YES at step S1302), and the prescribed time period has elapsed (YES at step S1303), the printer image on which the cursor is placed is identified (at step S1304); the setting information management section of the printer driver corresponding to the identified printer is inquired for reading out the setting information stored in the setting information storage section (at step S1305); and the tool tip is displayed (at step S1306).

When the cursor is moved (YES at step S1307), the tool tip window is closed (at step S1308); and when the printer screen is closed (NO at step S1309), the procedure for processing is ended.

Further, at the step S1303, when the cursor is moved (YES at step S1310) before the prescribed time period has elapsed (NO at step S1303), the tool tip will not be displayed.

Next, the processing for displaying the tool tip indicating the setting information control will be described in detail with reference to a specific embodiment.

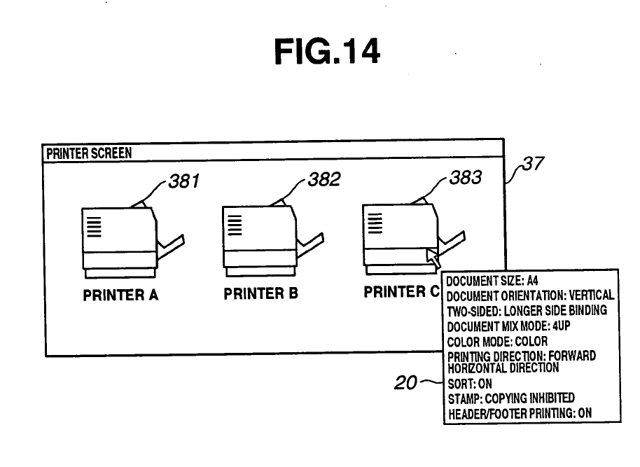

FIG. 14 is a drawing illustrating an example of printer screen 37 displayed on the displaying apparatus.

As shown in FIG. 14, the printer screen displays printer images indicating the destination printers (in FIG. 14, a printer A image 381, a printer B image 382, and a printer C image 383). Each of these printer images is correlated to the printer driver for setting the information for the pertinent printer and giving a printer instruction, and by designating a particular printer image, the information setting screen for the pertinent printer driver can be displayed, and the initial values for the setting information can be set.

By placing the cursor on the printer A image 381, the printer B image 382, or the printer C image 383 for a prescribed time period, the tool tip indicating the setting information set and stored in the printer driver corresponding to the pertinent printer image is displayed. For example, as shown in FIG. 14, when the cursor is placed on the printer C image 383, the setting information set in the printer driver corresponding to the printer C image 383 (“A4” for “document size”; vertical” for “orientation of document”; “longer side binding” for “two-sided”; “4 up” for “document mix mode”; “color” for “color mode”; “forward horizontal direction” for “printing direction”; “sort ON” for “sort”; “copying inhibited for “stamp”; and “ON” for “header/footer printing”) are displayed as a tool tip 20.

Therefore, by using the tool tip for collectively expressing the setting information as text information without the need for opening the printer driver corresponding to the printer image, the user is allowed to comprehend the relationship between the printer image and the setting information set for the printer with a less effort of operation.

In the above-stated embodiments, displaying the setting information as a tool tip by placing the cursor on the prescribed image has been described, however, the present invention is not limited to this, but may be configured such that the setting information displayed as a tool tip can be edited.

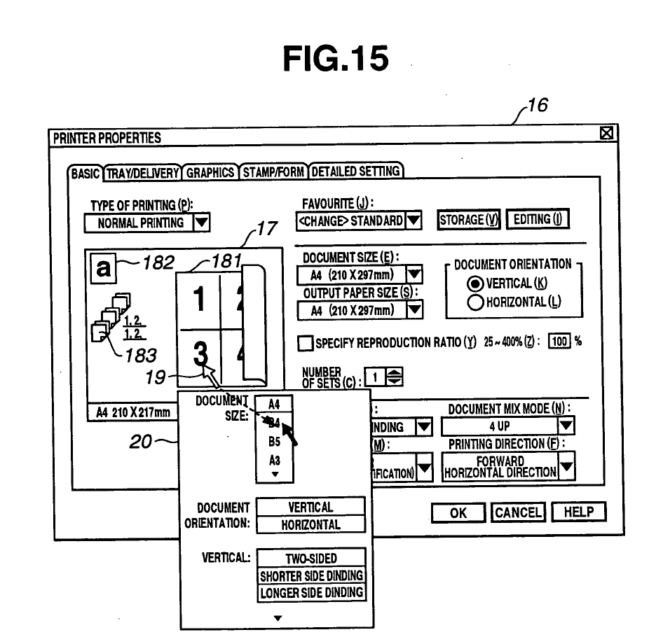

When the cursor is placed on the prescribed image to display the tool tip, and then moving the cursor to leave the cursor from the region of the prescribed image will close the tool tip window, however, as shown in FIG. 15, the present invention may be configured such that the setting information can be altered by depressing a specific key or the like (for example, the shift key on the keyboard) with the tool tip 20 being displayed, in order to fix the display of the tool tip 20, and moving the cursor 19 to specify the setting information to be edited (in the figure, placing the cursor on the setting information selected from the listed items and clicking).

The present invention is also applicable to any configuration in which a peripheral device control apparatus having the same functions as those of the above-described printer driver is connected to the client.

The entire disclosures of Japanese Patent Application No. 2003-358051 filed on Oct. 17, 2003 and Japanese Patent Application No. 2004-295088 filed on Oct. 7, 2004 including specifications, claims, drawings and abstracts are incorporated herein by reference in their entireties.

1. A peripheral device control program which provides a peripheral device with setting information corresponding to setting items set by a user, wherein a computer is caused to implement:
processing for display controlling of image data corresponding to the setting information on a display; and,
processing for displaying of text information corresponding to the image data on the display, when a prescribed time period has elapsed since the image data displayed on the display has been designated with an inputting unit.

2. The peripheral device control program of claim 1, wherein a plurality of setting items are previously divided into one or a plurality of groups; and a computer is caused to implement:
processing for display controlling of image data corresponding to setting information corresponding to setting items included in the groups on the display; and,
processing for displaying of text information corresponding to the image data on the display, when a prescribed time period has elapsed since the image data displayed on the display has been designated with the inputting unit

3. The peripheral device control program of claim 1, wherein a computer is caused to implement:
processing for dividing a plurality of setting items into groups;
processing for display controlling of image data corresponding to setting information corresponding to setting items included in the groups on the display; and,
processing for displaying of text information corresponding to the image data on the display, when a prescribed time period has elapsed since the image data displayed on the display has been designated with the inputting means.

4. The peripheral device control program of claim 1, wherein a computer is caused to implement:
processing for displaying a window in which the text information is given, when a prescribed time period has elapsed since a mouse cursor has been placed on the image data with the inputting unit.

5. A peripheral device control program which provides a peripheral device with setting information corresponding to setting items set by a user, wherein a computer is caused to implement:
processing for display controlling of image data corresponding to a plurality of pieces of setting information on a display; and,
processing for displaying of text information corresponding to the plurality of pieces of setting information on the display, when a prescribed time period has elapsed since the image data displayed on the display has been designated with an inputting unit.

6. The peripheral device control program of claim 5, wherein a plurality of setting items are previously divided into one or a plurality of groups; and a computer is caused to implement:
processing for display controlling of image data corresponding to setting information corresponding to setting items included in the groups on the display; and,
processing for displaying of text information corresponding to the setting information corresponding to the groups on the display, when a prescribed time period has elapsed since the image data has been designated with the inputting unit.

7. The peripheral device control program of claim 5, wherein a computer is caused to implement:
processing for dividing a plurality of setting items into groups;
processing for display controlling of image data corresponding to setting information corresponding to setting items included in the groups on the display; and,
processing for displaying of text information corresponding to the setting information corresponding to the groups on the display, when a prescribed time period has elapsed since the image data has been designated with the inputting unit.

8. The peripheral device control program of claim 5, wherein a computer is caused to implement:
in processing for displaying the text information for the setting information,
holding attribute information about whether or not the text information is to be displayed for the setting information corresponding to the setting items,
processing for selecting only the text information for the setting information provided with an attribute to display in the attribute information, on the basis of the attribute information; and
processing for display controlling of the selected text information on the display.

9. A peripheral device control program which provides a peripheral device with setting information corresponding to setting items set by a user, wherein a computer is caused to implement:
holding attribute information about whether or not text information is to be displayed for the setting information corresponding to the setting items,
processing for display controlling of the text information corresponding to the setting information on display, on the basis of the attribute information.

10. The peripheral device control program of claim 9, wherein a computer is caused to implement:
in processing for displaying the text information for the setting information for a plurality of pieces of setting items;
processing for selecting only the text information for the setting information provided with an attribute to display in the attribute information, on the basis of the attribute information about whether or not the text information is to be displayed for the setting information; and
processing for display controlling of the selected text information on the display.

11. A display control program which carries out display controlling of a display, wherein a computer is caused to implement:
processing for display controlling image data corresponding to a peripheral device on the display;
processing for identifying the peripheral device corresponding to the image data, when a prescribed time period has elapsed since the image data displayed on the display has been designated with an inputting unit;
processing for reading out the setting information set in the peripheral device control program corresponding to the specified peripheral device; and
processing for displaying the text information indicating the read out setting information on the display.

12. A peripheral device control apparatus which displays setting information corresponding to setting items set by a user on a display, comprising:
a setting information storage unit that stores the setting information;
a setting information management unit that manages the setting information stored in the setting information storage unit;
an image data display controller that displays image data corresponding to the setting information on the display; and,
a text information display controller that, when a prescribed time period has elapsed since the image data displayed on the display has been designated with an inputting unit, displays text information corresponding to the image data on the display.

13. The peripheral device control apparatus of claim 12, wherein the setting information management unit comprises a group management unit that previously divides a plurality of setting items into one or a plurality of groups,
the image data display controller displays image data corresponding to setting information corresponding to setting items included in the groups on the display, and
when a prescribed time period has elapsed since the image data displayed on the display has been designated with the inputting unit, the text information display controller displays text information corresponding to the image data on the display.

14. The peripheral device control apparatus of claim 12, wherein, when a prescribed time period has elapsed since a mouse cursor has been placed on the image data with the inputting unit, the text information display controller displays a window in which the text information is given.

15. A peripheral device control apparatus which displays setting information corresponding to setting items set by a user on a display, comprising:
a setting information storage unit that stores a plurality of pieces of setting information;
a setting information management unit that manages the plurality of pieces of setting information stored in the setting information storage unit;
an image data display controller that displays image data corresponding to the plurality of pieces of setting information on the display; and,
a text information display controller that, when a prescribed time period has elapsed since the image data displayed on the display has been designated with an inputting unit, displays text information corresponding to the plurality of pieces of setting information on the display.

16. The peripheral device control apparatus of claim 15, wherein the setting information management unit comprises group management unit that previously divides a plurality of setting items into one or a plurality of groups,
the image data display controller displays image data corresponding to setting information corresponding to setting items included in the groups on the display, and
when a prescribed time period has elapsed since the image data has been designated with the inputting unit, the text information display controller displays text information corresponding to the setting information corresponding to the groups on the display.

17. The peripheral device control apparatus of claim 15, wherein the setting information management unit comprises setting information attribute management unit that holds attribute information about whether or not the text information is to be displayed for the setting information corresponding to the setting items, and
the text information display controller selects, on the basis of the attribute information, only the text information for the setting information provided with an attribute to display in the attribute information, and displays the selected text information on the display.

18. A peripheral device control apparatus which displays setting information corresponding to setting items set by a user on a display, comprising:
a setting information attribute management unit that holds attribute information about whether or not text information is to be displayed for the setting information corresponding to the setting items; and
a text information display controller that, on the basis of the attribute information, displays the text information corresponding to the setting information on the display.

19. The peripheral device control apparatus of claim 18, wherein the text information display controller selects, on the basis of the attribute information about whether or not the text information is to be displayed for the setting information, only the text information for the setting information provided with an attribute to display in the attribute information, and
displays the selected text information on the displaying unit.

20. A display control apparatus which carries out display controlling of a display, comprising:
an image data display controller that displays image data corresponding to a peripheral device on the display;
an identifying unit that, when a prescribed time period has elapsed since the image data displayed on the display has been designated with an inputting unit, identifies the peripheral device corresponding to the image data;
a reading-out unit that reads out the setting information set in the peripheral device control program corresponding to the peripheral device identified with the identifying unit; and
a text information display controller that displays the text information indicating the setting information read out with the reading-out unit on the display.

21. A peripheral device control method which displays setting information corresponding to setting items set by a user on a display, comprising:
displaying image data corresponding to the setting information on the display; and,
displaying text information corresponding to the image data on the display, when a prescribed time period has elapsed since the image data displayed on the display has been designated with an inputting unit.

22. The peripheral device control method of claim 21, wherein a plurality of setting items are previously divided into one or a plurality of groups,
displaying image data corresponding to setting information corresponding to setting items included in the groups on the display, and
displaying text information corresponding to the image data on the display, when a prescribed time period has elapsed since the image data displayed on the display has been designated with the inputting unit.

23. The peripheral device control method of claim 22, wherein, when a prescribed time period has elapsed since a mouse cursor has been placed on the image data with the inputting unit, a window in which the text information is given is displayed.

24. A peripheral device control method which displays setting information corresponding to setting items set by a user on a display, comprising:
displaying image data corresponding to a plurality of pieces of setting information on the display; and,
displaying text information corresponding to the plurality of pieces of setting information on the display, when a prescribed time period has elapsed since the image data displayed on the display has been designated with an inputting unit.

25. The peripheral device control method of claim 24, wherein a plurality of setting items are previously divided into one or a plurality of groups,
displaying image data corresponding to setting information corresponding to setting items included in the groups on the display, and
displaying text information corresponding to the setting information corresponding to the groups is displayed on the display, when a prescribed time period has elapsed since the image data has been designated with the inputting unit.

26. The peripheral device control method of claim 24, further comprising:
holding attribute information about whether or not the text information is to be displayed for the setting information corresponding to the setting items;
selecting only the text information for the setting information provided with an attribute to display in the attribute information, on the basis of the attribute information; and
displaying the selected text information on the display.

27. A peripheral device control method which displays setting information corresponding to setting items set by a user on a display, comprising:
holding attribute information about whether or not the text information is to be displayed for the setting information corresponding to the setting items; and
displaying the text information corresponding to the setting items on the display, on the basis of the attribute information.

28. The peripheral device control method of claim 27, further comprising:
selecting only the text information for the setting information provided with an attribute to display in the attribute information, on the basis of the attribute information about whether or not the text information is to be displayed for the setting information; and
displaying the selected text information on the display.

29. A display control method which carries out display controlling of a display, comprising:
displaying image data corresponding to a peripheral device on the display;
identifying the peripheral device corresponding to the image data, when a prescribed time period has elapsed since the image data displayed on the display has been designated with an inputting unit;
reading out the setting information set in the peripheral device control program corresponding to the identified peripheral device; and
displaying the text information indicating the read out setting information on the display.
